(19) United States
(12) Patent Application Publication
(10) Pub. No.: US 2026/0213660 A1
(43) Pub. Date: Jul. 23, 2026

(54) DC-DC CONVERTER

(71) Applicant: Nuvoton Technology Corporation Japan, Kyoto (JP)

(72) Inventors: Naoki KAWAMOTO, Kyoto (JP); Takashi RYU, Kyoto (JP); Takuya ISHII, Kyoto (JP); Tetsuya MIHASHI, Kyoto (JP); Koji SUZUKI, Kyoto (JP)

(21) Appl. No.: 19/572,160

(22) Filed: Mar. 19, 2026

Related U.S. Application Data
(63) Continuation of application No. PCT/JP2024/034236, filed on Sep. 25, 2024.

(30) Foreign Application Priority Data
Sep. 27, 2023 (JP) 2023-165200

(51) Int. Cl. H02M 3/158; H02M 1/00; H02M 1/088; H02M 1/15

(52) U.S. Cl. CPC H02M 3/158; H02M 1/0025; H02M 1/088; H02M 1/15

(57) ABSTRACT

A DC-DC converter that controls output power of direct current (DC) by controlling on and off of a high-side switch, and the DC-DC converter includes: a controller that adjusts an off-time of the high-side switch for controlling the output power. In the DC-DC converter, the controller makes an on-time of the high-side switch inversely proportional to an input-output voltage difference that is a difference between an input voltage to the DC-DC converter and an output voltage from the DC-DC converter.

### CROSS REFERENCE TO RELATED APPLICATIONS

This is a continuation application of PCT International Patent Application No. PCT/JP2024/034236 filed on Sep. 25, 2024, designating the United States of America, which is based on and claims priority of Japanese Patent Application No. 2023-165200 filed on Sep. 27, 2023. The entire disclosures of the above-identified applications, including the specifications, drawings and claims are incorporated herein by reference in their entirety.

### FIELD

The present disclosure relates to a DC-DC converter.

### BACKGROUND

A buck converter includes a high-side switch that performs high-frequency switching of an input voltage, a low-side switch that alternately turns on and off with the high-side switch, an inductor and an output capacitor that average the electric potential at a connection point between the high-side switch and the low-side switch to supply an output voltage to a load, and a controller that performs a switching control of the high-side switch and the low-side switch. Note that a diode specialized for rectifying operation is often used instead of the low-side switch. The proportion of the on-time of the high-side switch to the switching period is referred to as time ratio δ, and the following relationship (Expression 1) is substantially satisfied between input voltage Ei and output voltage Eo.

Eo=δ·Ei (Expression 1)

In General, a buck converter controls output voltage Eo by adjusting time ratio δ.

In the case where time ratio δ becomes significantly small when an input voltage is high, adjustment of time ratio δ (on-time) is difficult. Patent Literature (PTL) 1 thus proposes a control method of adjusting the off-time with the on-time of the high-side switch being fixed. The DC-DC converter of PTL 1 generates a modulation signal according to a reference voltage, a feedback voltage from an output voltage, and a ripple current of an inductor that has been extracted, sets the off-time according to the modulation signal, and sets the on-time according to a constant on-time control signal. More specifically, the DC-DC converter of PTL 1 performs a switching control by comparing a signal obtained by adding the modulation signal to the feedback voltage with the reference voltage, or by comparing a signal obtained by subtracting the modulation signal from the reference voltage with the feedback voltage. Since the switching control is performed with the amplitude of the modulating signal equivalently as hysteresis, this control method is referred to as a hysteresis control. PTL 2 describes an example of the hysteresis control in which, although not a method in which the on-time is fixed, a modulation signal according to the ripple current is subtracted from a reference voltage. In General, in the hysteresis control, the larger the hysteresis, the more stable the feedback control system becomes, but the regulation tends to deteriorate.

### CITATION LIST

### Patent Literature

PTL 1: U.S. Pat. No. 10,587,196
PTL 2: Japanese Unexamined Patent Application Publication No. 2007-89278

### SUMMARY

### Technical Problem

However, with the DC-DC converter of PTL 1, a current ripple extractor for extracting the ripple current of the inductor is required, and thus the controller increases in scale. Since the technique of PTL 2 is not a method in which the on-time is fixed, it is difficult to perform the control when the input voltage is high.

In addition, PTL 1 also proposes a control method that makes the on-time inversely proportional to the input voltage. This method has an advantageous effect of being able to stabilize the operating frequency (switching frequency) as compared to the case where the on-time is fixed regardless of input/output conditions. However, the amplitude of the ripple current varies depending on the input voltage. In particular, when the input voltage is low, the amplitude of the ripple current becomes small, and thus the hysteresis becomes small, leading to a problem of becoming a factor for deterioration of the stability of the output voltage.

The present provides a DC-DC converter capable of achieving both suppression of variation in switching frequency and suppression of variation in amplitude of ripple current.

### Solution to Problem

A DC-DC converter according to one aspect of the present disclosure is a DC-DC converter that controls output power of direct current (DC) by controlling on and off of a high-side switch, and the DC-DC converter includes: a controller that adjusts an off-time of the high-side switch for controlling the output power. In the DC-DC converter, the controller makes an on-time of the high-side switch inversely proportional to an input-output voltage difference that is a difference between an input voltage to the DC-DC converter and an output voltage from the DC-DC converter.

General and specific aspects described above may be implemented using a system, a method, an integrated circuit, a computer program, or a computer-readable recording medium such as a compact disc read only memory (CD-ROM), or any combination of systems, methods, integrated circuits, computer programs, or computer-readable recording media.

### Advantageous Effects

With the DC-DC converter according to the present disclosure, it is possible to achieve both suppression of variation in switching frequency and suppression of variation in amplitude of ripple current.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a circuit configuration diagram illustrating a configuration of a DC-DC converter according to Embodiment 1.

FIG. 2 is a waveform diagram illustrating operations of the DC-DC converter according to Embodiment 1.

FIG. 3A is a characteristic diagram indicating a switching frequency with respect to an input voltage of the DC-DC converter of the present disclosure and a conventional DC-DC converter.

FIG. 3B is a characteristic diagram indicating an amplitude of ripple current with respect to an input voltage of the DC-DC converter of the present disclosure and the conventional DC-DC converter.

FIG. 4 is a circuit configuration diagram illustrating a configuration of a DC-DC converter according to Embodiment 2.

FIG. 5 is a waveform diagram illustrating operations of the DC-DC converter according to Embodiment 2.

FIG. 6 is a circuit configuration diagram illustrating a configuration of a DC-DC converter according to Embodiment 3.

FIG. 7 is a waveform diagram illustrating operations of the DC-DC converter according to Embodiment 3.

FIG. 8 is a circuit diagram illustrating a configuration of constant current source according to another embodiment.

### DESCRIPTION OF EMBODIMENTS

Hereinafter, embodiments of the present disclosure will be described with reference to the Drawings. It should be noted that each of the exemplary embodiments described below shows one specific example of the present disclosure. The numerical values, shapes, materials, structural components, the arrangement and connection of the structural components, steps, the processing order of the steps etc. described in the following embodiments are mere examples, and therefore do not limit the scope of the present disclosure. In addition, the respective diagrams are not necessarily precise illustrations. In each of the diagrams, substantially the same structural components are assigned with the same reference signs, and there are instances where redundant descriptions will be omitted or simplified. In addition, “connection” means electrical connection, and includes not only the case where two circuit elements are directly connected, but also the case where two circuit elements are indirectly connected with another circuit element inserted between the two circuit elements.

In addition, “proportional” described below may be “substantially proportional”, and “inversely proportional” may be “substantially inversely proportional”. For example, when the coefficient in the case where y is proportional to x is denoted as “a”, substantially proportional and substantially inversely proportional mean that “a” does not necessarily have to be a fixed value depending on the value of x, and “a” may vary somewhat depending on the value of x. For example, the variation range of a is within ±10% with respect to a representative value (such as an average value, a median value, or a mode value) of the values that a can take.

### Embodiment 1

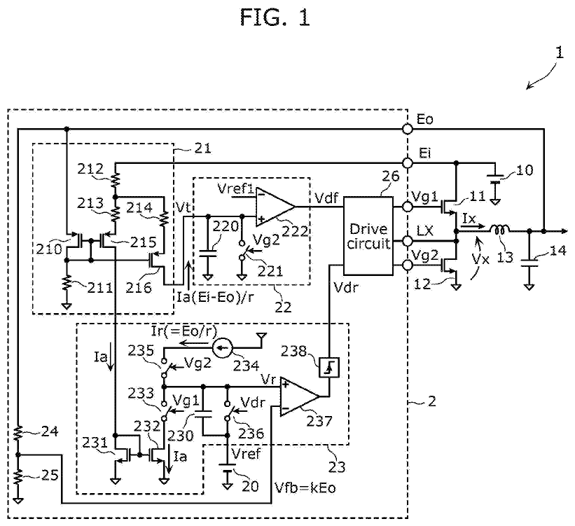

FIG. 1 is a circuit configuration diagram illustrating a configuration of DC-DC converter 1 according to Embodiment 1.

DC-DC converter 1 controls output power of direct current (DC), by controlling on and off of high-side switch 11. In FIG. 1, DC-DC converter 1 is a buck converter that steps down input voltage Ei from DC power supply 10 such as a battery to DC-DC converter 1, and supplies output voltage Eo from DC-DC converter 1 to a load (not illustrated). DC-DC converter 1 includes high-side switch 11, low-side switch 12, inductor 13, output capacitor 14, and controller 2. In DC-DC converter 1, a series configuration of high-side switch 11 and low-side switch 12 is connected in parallel with DC power supply 10, one end of inductor 13 with inductance L is connected to connection point LX of high-side switch 11 and low-side switch 12, and output capacitor 14 is connected to the other end of inductor 13. A voltage across both ends of output capacitor 14 is output as output voltage Eo. High-side switch 11 and low-side switch 12 are, for example, N type metal oxide semiconductor (NMOS) transistors. Note that DC-DC converter 1 may include a diode instead of low-side switch 12.

Controller 2 adjusts the off-time of high-side switch 11 to control the output power. For example, controller 2 includes reference voltage source 20 that generates reference voltage Vref, current source circuit 21 that receives input voltage Ei and output voltage Eo to generate current proportional to an input-output voltage difference (Ei−Eo) that is a difference between input voltage Ei and output voltage Eo, on-time setting circuit 22 that is supplied with the current proportional to the input-output voltage difference (Ei−Eo) to output turn-off signal Vdf, off-time setting circuit 23 that generates ramp voltage Vr by superimposing a modulation signal on reference voltage Vref, compares ramp voltage Vr with feedback voltage Vfb which will be described later to output a turn-on signal Vdr, resistors 24 and 25 that compose a feedback circuit that divides output voltage Eo to generate feedback voltage Vfb corresponding to output voltage Eo, and drive circuit 26 that receives turn-off signal Vdf and turn-on signal Vdr to output drive signal Vg1 for high-side switch 11 and drive signal Vg2 for low-side switch 12. Although the details will be described later, controller 2, by having such a configuration, is capable of making the on-time of high-side switch 11 inversely proportional to the input-output voltage difference (Ei−Eo).

Here, when resistance values of resistors 24 and 25 are denoted as R4 and R5, respectively, and voltage division ratio k=R5/(R4+R5), feedback voltage Vfb can be expressed as (Expression 2) indicated below.

Vfb=Eo·R5/(R4+R5)=k·Eo (Expression 2)

Note that, in order to avoid simultaneous turning on of high-side switch 11 and low-side switch 12, drive circuit 26 causes drive signal Vg2 to fall at the timing when turn-on signal Vdr rises to turn off low-side switch 12, and then causes drive signal Vg1 to rise to turn on high-side switch 11. Then, drive circuit 26 causes drive signal Vg1 to fall at the timing when turn-off signal Vdf rises to turn off high-side switch 11, and then causes drive signal Vg2 to rise to turn on low-side switch 12.

Current source circuit 21 includes P type metal oxide semiconductor (PMOS) transistor 210 that is applied with output voltage Eo at the source, resistor 211 for causing current to flow through PMOS transistor 210, resistor 212 that is applied with input voltage Ei at one end, resistors 213 and 214 with one ends connected to the other end of resistor 212, PMOS transistor 215 with the source connected to the other end of resistor 213, and PMOS transistor 216 with the source connected to the other end of resistor 214. The gate and drain of PMOS transistor 210, the gate of PMOS transistor 215, and the gate of PMOS transistor 216 are connected to each other. With this configuration, the source voltages of PMOS transistor 215 and PMOS transistor 216 both become equal to output voltage Eo. When the resistance values of resistors 212, 213, and 214 are denoted as R, Ra, and Rb, respectively, the current flowing out from the drain of PMOS transistor 215 through resistor 213 is denoted as Ia, and the current flowing out from the drain of PMOS transistor 216 through resistor 214 is denoted as Ib, currents Ia and Ib can be expressed as (Expression 3a) and (Expression 3b) as indicated below.

Ia=(Ei−Eo)/{Ra+R(1+Ra/Rb)} (Expression 3a)

Ib=(Ei−Eo)/{Rb+R(1+Rb/Ra)} (Expression 3b)

For simplification, assuming R=Ra=Rb=r/3, currents Ia and Ib can be expressed as (Expression 3) indicated below.

Ia=Ib=(Ei−Eo)/r (Expression 3)

The drain of PMOS transistor 215 is connected to off-time setting circuit 23, the drain of PMOS transistor 216 is connected to on-time setting circuit 22, and current Ia proportional to the input-output voltage difference (Ei−Eo) is supplied to each of on-time setting circuit 22 and off-time setting circuit 23.

On-time setting circuit 22 includes: on-time setting capacitor 220 through which current from current source circuit 21 flows, and which is connected to the drain of PMOS transistor 216; switch 221 that short-circuits both ends of on-time setting capacitor 220 in accordance with drive signal Vg2; and comparator 222 that compares voltage Vt of on-time setting capacitor 220 and reference voltage Vref1. Turn-off signal Vdf is output from comparator 222. Specifically, switch 221 is on while drive signal Vg2 is rising, and short-circuits the both ends of on-time setting capacitor 220 (in other words, discharges on-time setting capacitor 220). Reference voltage Vref1 may be the same as reference voltage Vref of reference voltage source 20, but reference voltage Vref1 and reference voltage Vref are described separately to avoid confusion in expressions. Although the details will be described later, on-time setting circuit 22, by having such a configuration, turns off high-side switch 11 when an amount of change in voltage of on-time setting capacitor 220 from a turn-on time point of high-side switch 11 reaches a predetermined value (for example, reference voltage Vref1).

Off-time setting circuit 23 includes: off-time setting capacitor 230 connected to reference voltage source 20 at one end and outputs ramp voltage Vr from the other end; a current mirror that includes NMOS transistor 231 and NMOS transistor 232, and is for drawing the same current as current Ia from the drain of PMOS transistor 215; switch 233 that connects the drain of NMOS transistor 232 and the other end of off-time setting capacitor 230 in accordance with drive signal Vg1; constant current source 234 for charging off-time setting capacitor 230 with constant current Ir; switch 235 that connects constant current source 234 to the other end of off-time setting capacitor 230 in accordance with drive signal Vg2; switch 236 that short-circuits the both ends of off-time setting capacitor 230 in accordance with turn-on signal Vdr; comparator 237 that compares ramp voltage Vr and feedback voltage Vfb; and trigger circuit 238 that outputs turn-on signal Vdr that serves as a one-shot pulse in accordance with the rising edge of the output of comparator 237.

Specifically, switch 233 is on while drive signal Vg1 is rising, and connects the drain of NMOS transistor 232 and the other end of off-time setting capacitor 230 (in other words, discharges off-time setting capacitor 230). Switch 235 is on while drive signal Vg2 is rising, and connects constant current source 234 and the other end of off-time setting capacitor 230 (in other words, discharges off-time setting capacitor 230). Switch 236 is on while turn-on signal Vdr is rising, and short-circuits the both ends of off-time setting capacitor 230 (in other words, causes ramp voltage Vr to become reference voltage Vref). Here, for simplification, the current drawn by NMOS transistor 232 is assumed to be set to be equal to current Ia from the drain of PMOS transistor 215.

Although the details will be described later, off-time setting circuit 23, by having such a configuration, charges the voltage of off-time setting capacitor 230 up to a predetermined voltage (for example, reference voltage Vref) when high-side switch 11 turns on, discharges off-time setting capacitor 230 with current Ia from current source circuit 21 proportional to the input-output voltage difference (Ei−Eo) during the on-period of high-side switch 11, charges off-time setting capacitor 230 with a predetermined constant current or current Ir proportional to output voltage Eo during the off-period of high-side switch 11, and turns on high-side switch 11 when the voltage of off-time setting capacitor 230 reaches feedback voltage Vfb.

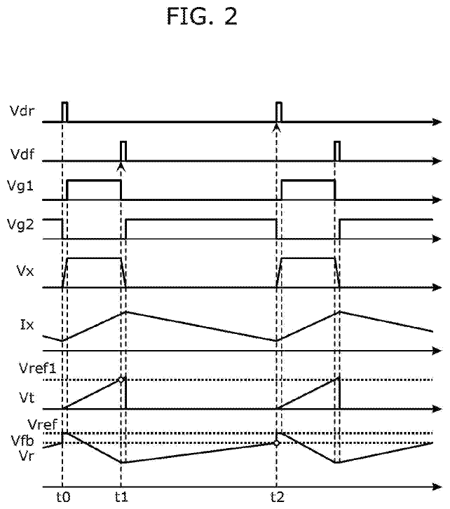

Next, the details of the operations of DC-DC converter 1 (specifically, the operations of controller 2) will be described with reference to FIG. 2.

FIG. 2 is a waveform diagram illustrating the operations of DC-DC converter 1 according to Embodiment 1. FIG. 2 is an operating waveform diagram for each main section of DC-DC converter 1 of Embodiment 1 illustrated in FIG. 1, and shows, from the top, turn-on signal Vdr, turn-off signal Vdf, drive signal Vg1, drive signal Vg2, LX terminal voltage Vx, inductor current Ix, voltage Vt of on-time setting capacitor 220, and ramp voltage Vr.

At time t0, turn-on signal Vdr rises and drive signal Vg2 falls to turn off low-side switch 12, and drive signal Vg1 rises to turn on high-side switch 11, causing LX terminal voltage Vx to change from the zero potential to input voltage Ei. The input-output voltage difference (Ei−Eo) is applied to inductor 13, and inductor current Ix increases with slope (Ei−Eo)/L. In addition, switch 236 turns on as a result of turn-on signal Vdr rising, and the voltage of off-time setting capacitor 230 (ramp voltage Vr) is charged up to reference voltage Vref. In on-time setting circuit 22 of controller 2, switch 221 turns off as a result of drive signal Vg2 falling, on-time setting capacitor 220 is charged with current Ia=(Ei−Eo)/r, and voltage Vt increases. On the other hand, in off-time setting circuit 23, switch 233 turns on as a result of drive signal Vg1 rising, switch 235 turns off as a result of drive signal Vg2 falling, off-time setting capacitor 230 is discharged with current Ia, and ramp voltage Vr falls from reference voltage Vref.

At time t1, when voltage Vt of on-time setting capacitor 220 reaches reference voltage Vref1, turn-off signal Vdf output from comparator 222 rises, drive signal Vg1 falls, and high-side switch 11 turns off. Then drive signal Vg2 rises, and low-side switch 12 turns on.

Here, time from time t0 to time t1 is on-time Ton of high-side switch 11. When the electrostatic capacitance of on-time setting capacitor 220 is denoted as Ct, on-time Ton is expressed as (Expression 4) indicated below.

Ton=Ct·Vref1·r/(Ei−Eo) (Expression 4)

As indicated in (Expression 4), on-time Ton is inversely proportional to input-output voltage difference (Ei−Eo). Increase ΔIx (amplitude of ripple current) of inductor current Ix during this on-time Ton is expressed as (Expression 5) indicated below.

ΔIx=(Ei−Eo)·Ton/L=Ct·Vref1·r/L (Expression 5)

Furthermore, when the electrostatic capacitance of off-time setting capacitor 230 is denoted as Cr, decrease ΔVr of ramp voltage Vr is expressed as (Expression 6) indicated below.

ΔVr=Ia·Ton/Cr=Ct·Vref1/Cr (Expression 6)

(Expression 5) and (Expression 6) show that increase ΔIx of inductor current Ix and decrease ΔVr of ramp voltage Vr are both constant values independent of input-output voltages.

Subsequent to time t1, due to the turning off of high-side switch 11 and the turning on of low-side switch 12, LX terminal voltage Vx becomes the zero potential, output voltage Eo is applied to inductor 13, and inductor current Ix decreases with slope Eo/L. In on-time setting circuit 22 of controller 2, switch 221 turns on as a result of drive signal Vg2 rising, voltage Vt of on-time setting capacitor 220 becomes zero, and turn-off signal Vdf output from comparator 222 falls. On the other hand, in off-time setting circuit 23, switch 233 turns off as a result of drive signal Vg1 falling and switch 235 turns on as a result of drive signal Vg2 rising, and thus off-time setting capacitor 230 is charged by the constant current from constant current source 234, and ramp voltage Vr starts to increase.

At time t2, when ramp voltage Vr reaches feedback voltage Vfb, the output of comparator 237 rises, and turn-on signal Vdr is output via trigger circuit 238. At the same time, switch 236 turns on as a result of turn-on signal Vdr rising, and ramp voltage Vr becomes reference voltage Vref. However, since turn-on signal Vdr is a one-shot pulse, switch 236 turns off immediately. Off-time setting capacitor 230 is discharged with current Ia, and ramp voltage Vr starts to fall. When drive signal Vg2 falls by turn-on signal Vdr, low-side switch 12 turns off, then drive signal Vg1 rises and high-side switch 11 turns on, LX terminal voltage Vx changes from the zero potential to input voltage Ei, and the same operations as those subsequent to time t0 are repeated.

Here, time from time t1 to time t2 is off-time Toff of high-side switch 11. The decrease of inductor current Ix during this off-time Toff is expressed as (Expression 7) indicated below.

ΔIx=Eo·Toff/L (Expression 7)

Since this decrease equals to the increase in a steady state, the relationship of (Expression 8) indicated below is obtained.

(Ei−Eo)·Ton=Eo·Toff (Expression 8)

From (Expression 8), Eo=Ei·Ton/(Ton+Toff)=δ·Ei which is the input-output relational expression of buck converter (Expression 1) is obtained. In addition, from (Expression 4) and (Expression 8), the relationship of (Expression 9) indicated below is also obtained.

Eo·Toff=Ct·Vref1·r (Expression 9)

On the other hand, when the current value from constant current source 234 of off-time setting circuit 23 is denoted as Ir, the relationship of (Expression 10) indicated below is obtained.

Vfb−Vref+ΔVr=Ir·Toff/Cr (Expression 10)

When (Expression 6) and (Expression 9) are substituted into (Expression 10) and Toff is eliminated, the relationship of (Expression 11) indicated below is obtained.

Vfb−Vref=(Ct/Cr)·Vref1·(r·Ir/Eo−1) (Expression 11)

From Vfb=k·Eo (Expression 2), it can be seen that output voltage Eo, although complex, is expressed by design constants and can be stabilized to an intended value. Here, by setting constant current Ir to Eo/r; that is, by making off-time Toff inversely proportional to output voltage Eo, (Expression 11) is simplified to (Expression 12) indicated below.

Vfb=Vref (Expression 12)

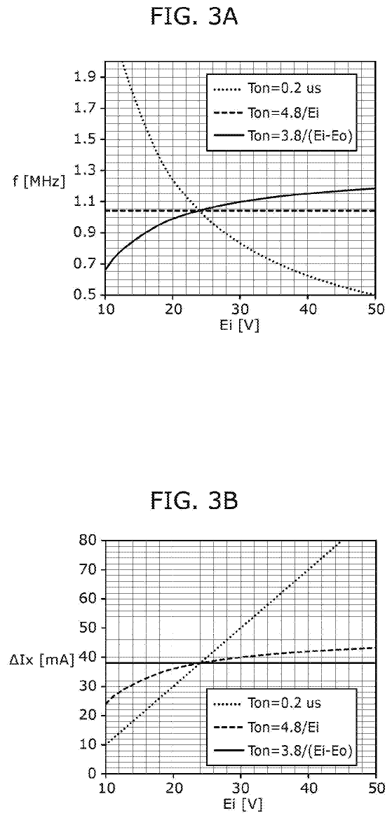

Next, the characteristics of DC-DC converter 1 of the present disclosure in which on-time Ton is inversely proportional to the input-output voltage difference (Ei−Eo) will be described with reference to FIG. 3A and FIG. 3B while comparing with a conventional DC-DC converter.

FIG. 3A is a characteristic diagram indicating switching frequency f with respect to input voltage Ei of the DC-DC converter of the present disclosure and the conventional DC-DC converter.

FIG. 3B is a characteristic diagram indicating amplitude (variation range) ΔIx of the ripple current with respect to input voltage Ei of DC-DC converter of the present disclosure and the conventional DC-DC converter. More specifically, FIG. 3A and FIG. 3B indicate, as the characteristics of conventional DC-DC converter, characteristics when the on-time is fixed (Ton=0.2 μsec) and characteristics when the on-time is inversely proportional to input voltage Ei (Ton=4.8/Ei), and indicate, as the characteristics of DC-DC converter 1 of the present disclosure, characteristics when the on-time is inversely proportional to the input-output voltage difference (Ei−Eo) (Ton=3.8/(Ei−Eo)). In addition, it is set such that input voltage Ei is 10 V to 50 V, output voltage Eo is 5 V, the inductance of inductor 13 is 100 μH, and on-time Ton becomes 0.2 μsec when input voltage Ei is 24 V.

When the on-time is fixed, switching frequency f and amplitude ΔIx of the ripple current both vary significantly, whereas when on-time Ton is inversely proportional to input voltage Ei, there is no variation in switching frequency f, and amplitude ΔIx of the ripple current decreases as input voltage Ei becomes lower. In contrast, when on-time Ton of the present disclosure is inversely proportional to the input-output voltage difference (Ei−Eo), there is almost no variation in amplitude ΔIx of the ripple current. On the other hand, switching frequency f decreases as input voltage Ei becomes lower, but the variation in switching frequency f is suppressed compared to the case where the on-time is fixed.

As described above, according to DC-DC converter 1 of the present disclosure, by making the on-time of high-side switch 11 inversely proportional to the input-output voltage difference (Ei−Eo), it is possible to achieve both the suppression of the variation in switching frequency f and the suppression of the variation in amplitude ΔIx of the ripple current. More specifically, it is possible to substantially eliminate the variation in amplitude ΔIx of the ripple current while suppressing the variation in switching frequency f, and to implement the stable operation over a wide range of input voltage Ei.

In addition, since current Ia that is caused to flow through on-time setting capacitor 220 is proportional to the input-output voltage difference (Ei−Eo), time that is until the amount of change in voltage of on-time setting capacitor 220 from the turn-on time point of high-side switch 11 reaches a predetermined value (for example, reference voltage Vref1), and corresponds to the on-time of high-side switch 11 is inversely proportional to the input-output voltage difference (Ei−Eo). Therefore, as a result of controller 2 including current source circuit 21 and on-time setting circuit 22, it is possible to make the on-time of high-side switch 11 inversely proportional to the input-output voltage difference (Ei−Eo).

In addition, in consideration of feedback voltage Vfb corresponding to output voltage Eo, time that is until the voltage of off-time setting capacitor 230 reaches feedback voltage Vfb from the turn-off time point of high-side switch 11, and corresponds to the off-time of high-side switch 11 is set. Therefore, as a result of controller 2 including the feedback circuit (resistors 24 and 25) and off-time setting circuit 23, it is possible to set the off-time of high-side switch 11 so as to suppress the variation in output voltage Eo, and to stabilize output voltage Eo.

### Embodiment 2

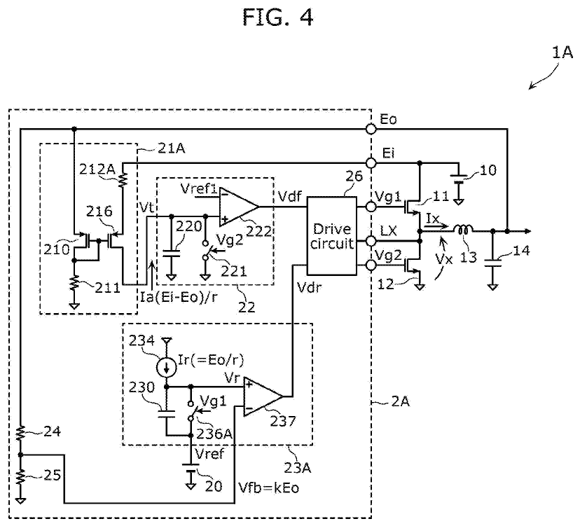

FIG. 4 is a circuit configuration diagram illustrating a configuration of DC-DC converter 1A according to Embodiment 2. In FIG. 4, the structural components similar to those of DC-DC converter 1 illustrated in FIG. 1 are assigned with the same reference numerals, and descriptions thereof will be omitted or simplified.

What differs in FIG. 4 from FIG. 1 is the configuration of controller 2A, and controller 2A is simplified with reduced structural components compared to controller 2 of FIG. 1. Current source circuit 21 of FIG. 1 is replaced with current source circuit 21A in FIG. 4, and in current source circuit 21A, resistor 213 and PMOS transistor 215 of current source circuit 21 are deleted, and resistors 212 and 214 are replaced with resistor 212A. When the resistance value of resistor 212A is denoted as r, current Ia output from the drain of PMOS transistor 216 is expressed by (Expression 13) indicated below, in the same manner as Embodiment 1.

Ia=(Ei−Eo)/r (Expression 13)

Off-time setting circuit 23 of FIG. 1 is replaced with off-time setting circuit 23A in FIG. 4, and in off-time setting circuit 23A, NMOS transistors 231 and 232 included in the current mirror, switches 233 and 235, and trigger circuit 238 in off-time setting circuit 23 are deleted, and switch 236 is replaced with switch 236A that short-circuits off-time setting capacitor 230 in accordance with drive signal Vg1. More specifically, switch 236A is on while drive signal Vg1 is rising and short-circuits the both ends of off-time setting capacitor 230 (in other words, discharges off-time setting capacitor 230 such that ramp voltage Vr becomes reference voltage Vref of reference voltage source 20).

Although the details will be described later, off-time setting circuit 23A, by having such a configuration, discharges off-time setting capacitor 230 down to a predetermined voltage (for example, reference voltage Vref) during the on-period of high-side switch 11, charges off-time setting capacitor 230 with a predetermined constant current or current Ir proportional to output voltage Eo during the off-period of high-side switch 11, and turns on high-side switch 11 when the voltage of off-time setting capacitor 230 reaches feedback voltage Vfb.

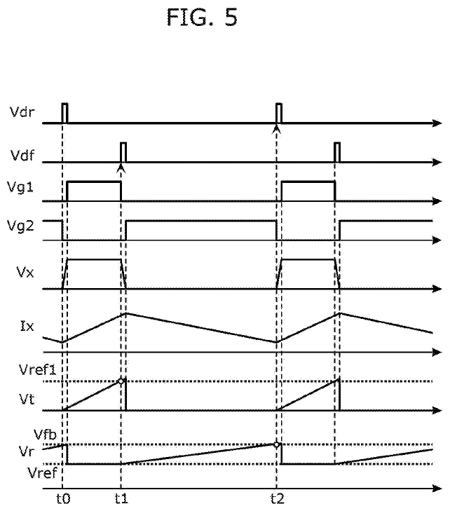

Next, the details of the operations of DC-DC converter 1A (specifically, the operations of controller 2A) will be described with reference to FIG. 5.

FIG. 5 is a waveform diagram illustrating the operations of DC-DC converter 1A according to Embodiment 2. FIG. 5 is an operating waveform diagram for each main section of DC-DC converter 1A of Embodiment 2 illustrated in FIG. 4, and shows, from the top, turn-on signal Vdr, turn-off signal Vdf, drive signal Vg1, drive signal Vg2, LX terminal voltage Vx, inductor current Ix, voltage Vt of on-time setting capacitor 220, and ramp voltage Vr.

At time t0, turn-on signal Vdr rises and drive signal Vg2 falls to turn off low-side switch 12, and drive signal Vg1 rises to turn on high-side switch 11, causing LX terminal voltage Vx to change from the zero potential to input voltage Ei. The input-output voltage difference (Ei−Eo) is applied to inductor 13, and inductor current Ix increases with slope (Ei−Eo)/L. In on-time setting circuit 22, as a result of switch 221 turning off, on-time setting capacitor 220 is charged with current Ia=(Ei−Eo)/r, and voltage Vt increases. On the other hand, in off-time setting circuit 23A, as a result of drive signal Vg1 rising, switch 236A turns on to short-circuit the both ends of off-time setting capacitor 230, and the voltage of off-time setting capacitor 230 (ramp voltage Vr) is discharged down to reference voltage Vref.

At time t1, when voltage Vt of on-time setting capacitor 220 reaches reference voltage Vref1, turn-off signal Vdf output from comparator 222 rises, drive signal Vg1 falls, and high-side switch 11 turns off. Then drive signal Vg2 rises, and low-side switch 12 turns on.

Here, similarly to Embodiment 1, on-time Ton of high-side switch 11 from time t0 to time t1 is expressed as (Expression 14) indicated below.

Ton=Ct·Vref1·r/(Ei−Eo) (Expression 14)

Increase ΔIx (amplitude of the ripple current) of inductor current Ix during this on-time Ton is expressed as (Expression 15) indicated below.

ΔIx=(Ei−Eo)·Ton/L=Ct·Vref1·r/L (Expression 15)

Similarly to Embodiment 1, increase ΔIx of inductor current Ix is a constant value independent of input-output voltages.

Subsequent to time t1, due to turning off of high-side switch 11 and turning on of low-side switch 12, LX terminal voltage Vx becomes a zero potential, output voltage Eo is applied to inductor 13, and inductor current Ix decreases with slope Eo/L. In on-time setting circuit 22 of controller 2, switch 221 turns on as a result of drive signal Vg2 rising, voltage Vt of on-time setting capacitor 220 becomes zero, and turn-off signal Vdf output from comparator 222 falls. On the other hand, in off-time setting circuit 23A, switch 236A turns off as a result of drive signal Vg1 falling, and thus off-time setting capacitor 230 is charged by the constant current from constant current source 234, and ramp voltage Vr increases.

At time t2, when ramp voltage Vr reaches feedback voltage Vfb, turn-on signal Vdr that is the output of comparator 237 rises. When drive signal Vg2 falls by turn-on signal Vdr, low-side switch 12 turns off, then drive signal Vg1 rises and high-side switch 11 turns on, and LX terminal voltage Vx changes from the zero potential to input voltage Ei. When drive signal Vg1 rises, switch 236A turns on and the both ends of off-time setting capacitor 230 are short-circuited, ramp voltage Vr becomes reference voltage Vref, comparator 237 is inverted, and turn-on signal Vdr falls. The same operations as those subsequent to time t0 are repeated.

Here, time from time t1 to time t2 is off-time Toff of high-side switch 11. The decrease of inductor current Ix during this off-time Toff is expressed as (Expression 16) indicated below.

ΔIx=Eo·Toff/L (Expression 16)

Since this decrease equals to the increase in a steady state, the relationship of (Expression 17) indicated below is obtained.

(Ei−Eo)·Ton=Eo·Toff (Expression 17)

From (Expression 17), Eo=Ei·Ton/(Ton+Toff)=δ·Ei which is the input-output relational expression of buck converter (Expression 1) is obtained. In addition, from (Expression 14) and (Expression 17), the relationship of (Expression 18) indicated below is also obtained.

Eo·Toff=Ct·Vref1·r (Expression 18)

On the other hand, when the current value from constant current source 234 of off-time setting circuit 23A is denoted as Ir, the relationship of (Expression 19) indicated below is obtained.

Vfb−Vref =Ir·Toff/Cr (Expression 19)

When (Expression 18) is substituted into (Expression 19) and Toff is eliminated, the relationship of (Expression 20) indicated below is obtained.

Vfb−Vref=(Ct/Cr)·Vref1·r·Ir/Eo (expression 20)

From Vfb=k·Eo (Expression 2), it can be seen that output voltage Eo, although complex, is expressed by design constants and can be stabilized to an intended value. Here, by setting constant current Ir to Eo/r; that is, by making off-time Toff inversely proportional to output voltage Eo, (Expression 20) is simplified to (Expression 21) indicated below.

Vfb=Vref+(Ct/Cr)·Vref1 (Expression 21)

Also in Embodiment 2, since on-time is inversely proportional to the input-output voltage difference (Ei−Eo), characteristic that there is substantially no variation in amplitude of the ripple current and variation in switching frequency is suppressed compared to the case where on-time is fixed is similar to Embodiment 1. What differs from Embodiment 1 is that the configuration of controller 2A is simplified compared to the configuration of controller 2.

In addition, also in Embodiment 2, in consideration of feedback voltage Vfb corresponding to output voltage Eo, time that is until the voltage of off-time setting capacitor 230 reaches feedback voltage Vfb from the turn-off time point of high-side switch 11, and corresponds to the off-time of high-side switch 11 is set. Therefore, as a result of controller 2A including the feedback circuit (resistors 24 and 25) and off-time setting circuit 23A, it is possible to set the off-time of high-side switch 11 so as to suppress the variation in output voltage Eo, and to stabilize output voltage Eo.

### Embodiment 3

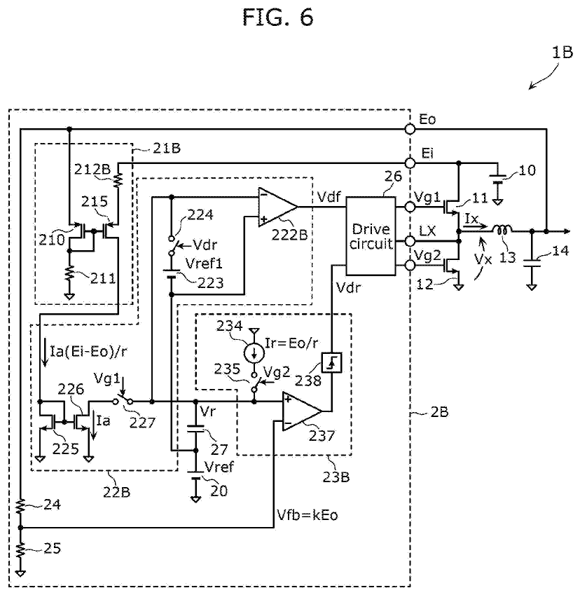

FIG. 6 is a circuit configuration diagram illustrating a configuration of DC-DC converter 1B according to Embodiment 3. In FIG. 6, the structural components similar to those of DC-DC converter 1 illustrated in FIG. 1 are assigned with the same reference numerals, and descriptions thereof will be omitted or simplified.

What differs in FIG. 6 from FIG. 1 is the configuration of controller 2B Current source circuit 21 of FIG. 1 is replaced with current source circuit 21B in FIG. 6, and in current source circuit 21B, resistor 214 and PMOS transistor 216 of current source circuit 21 are deleted, and resistors 212 and 213 are replaced with resistor 212B. When the resistance value of resistor 212B is denoted as r, current Ia output from the drain of PMOS transistor 215 is expressed by (Expression 22) indicated below, in the same manner as Embodiment 1.

Ia=(Ei−Eo)/r (Expression 22)

Off-time setting capacitor 230 of FIG. 1 is replaced with capacitor 27 in FIG. 6, and capacitor 27 serves both function of setting an off-time and function of setting an on-time. In other words, in FIG. 6, on-time setting capacitor 220 and off-time setting capacitor 230 are replaced with capacitor 27. The voltage obtained by adding the voltage of capacitor 27 to reference voltage Vref is defined as ramp voltage Vr. On-time setting circuit 22 of FIG. 1 is replaced with on-time setting circuit 22B in FIG. 6, and the negative input terminal of comparator 222B that outputs turn-off signal Vdf receives ramp voltage Vr, and reference voltage Vref is input to the positive input terminal. In addition, reference voltage source 223 that generates reference voltage Vref1 is added to reference voltage Vref, and switch 224 that sets ramp voltage Vr to reference voltage Vref+Vref1 in accordance with turn-on signal Vdr is connected. By the current mirror including NMOS transistors 225 and 226, the same current as current Ia from current source circuit 21B is drawn into NMOS transistor 226, and capacitor 27 is discharged through switch 227 that operates in accordance with drive signal Vg1. On the other hand, off-time setting circuit 23 of FIG. 1 is replaced with off-time setting circuit 23B in FIG. 6, and in off-time setting circuit 23B, switch 236 is deleted. In addition, the circuit corresponding to NMOS transistor 231, NMOS transistor 232, and switch 233 that discharge ramp voltage Vr during the on-period in FIG. 1 is replaced with the circuit corresponding to NMOS transistor 225, NMOS transistor 226, and switch 227 as described above in FIG. 6, and they are included in on-time setting circuit 22B as structural components.

Specifically, switch 224 is on while turn-on signal Vdr is rising, and connects the positive terminal of reference voltage source 223 to the positive input terminal of comparator 237 (in other words, charges the voltage of capacitor 27 up to reference voltage Vref +Vref1 when high-side switch 11 turns on). Specifically, switch 227 is on while drive signal Vg1 is rising, and connects the drain of NMOS transistor 226 and capacitor 27 (in other words, discharges capacitor 27 with current Ia from current source circuit 21B proportional to the input-output voltage difference (Ei−Eo) during the on-period of high-side switch 11).

Although the details will be described later, on-time setting circuit 22B charges voltage of capacitor 27 up to the first voltage (reference voltage Vref+Vref1) when high-side switch 11 turns on, discharges capacitor 27 with the current from current source circuit 21B proportional to the input-output voltage difference (Ei−Eo) during the on-period of high-side switch 11, and turns off high-side switch 11 when the voltage of high-side switch 11 reaches the second voltage (reference voltage Vref) that is lower than the first voltage.

Although the details will be described later, off-time setting circuit 23B charges capacitor 27 with a predetermined constant current or current Ir proportional to output voltage Eo during the off-period of high-side switch 11, and turns on high-side switch 11 when the voltage of capacitor 27 reaches feedback voltage Vfb.

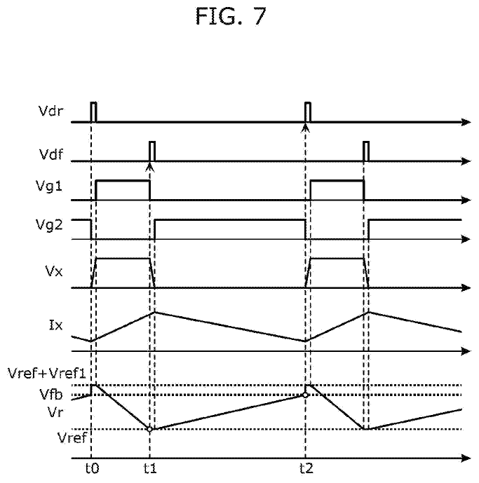

Next, the details of the operations of DC-DC converter 1B (specifically, the operations of controller 2B) will be described with reference to FIG. 7. FIG. 7 is a waveform diagram illustrating the operations of DC-DC converter 1B according to Embodiment 3. FIG. 7 is an operating waveform diagram for each main section of DC-DC converter 1B of Embodiment 3 illustrated in FIG. 6, and shows, from the top, turn-on signal Vdr, turn-off signal Vdf, drive signal Vg1, drive signal Vg2, LX terminal voltage Vx, inductor current Ix, and ramp voltage Vr.

At time t0, turn-on signal Vdr rises and drive signal Vg2 falls to turn off low-side switch 12, and drive signal Vg1 rises to turn on high-side switch 11, causing LX terminal voltage Vx to change from the zero potential to input voltage Ei. The input-output voltage difference (Ei−Eo) is applied to inductor 13, and inductor current Ix increases with slope (Ei−Eo)/L. In on-time setting circuit 22B, switch 224 turns on as a result of turn-on signal Vdr rising, ramp voltage Vr is charged up to reference voltage Vref+Vref1, and switch 224 turns off with the falling of turn-on signal Vdr of the one-shot pulse. In addition, switch 227 turns on as a result of drive signal Vg1 rising, and switch 235 of off-time setting circuit 23B turns off as a result of drive signal Vg2 falling, and thus capacitor 27 is discharged with current Ia and ramp voltage Vr decreases from reference voltage Vref+Vref1.

At time t1, when ramp voltage Vr decreases to reference voltage Vref, turn-off signal Vdf rises, drive signal Vg1 falls, and high-side switch 11 turns off. Then drive signal Vg2 rises, and low-side switch 12 turns on.

Here, time from time t0 to time t1 is on-time Ton of high-side switch 11. When the electrostatic capacitance of capacitor 27 is denoted as Cr, on-time Ton is expressed as (Expression 23) indicated below.

Ton=Cr·Vref1·r/(Ei−Eo) (Expression 23)

As indicated in (Expression 23), on-time Ton is inversely proportional to the input-output voltage difference (Ei−Eo). Increase ΔIx (amplitude of the ripple current) of inductor current Ix during this on-time Ton is expressed as (Expression 24) indicated below.

ΔIx=(Ei−Eo)·Ton/L=Ct·Vref1·r/L (Expression 24)

In addition, the decrease of ramp voltage Vr is Vref1, and increase ΔIx of inductor current Ix and the decrease of ramp voltage Vr are both constant values independent of the input-output voltages. Subsequent to time t1, due to the turning off of high-side switch 11 and the turning on of low-side switch 12, LX terminal voltage Vx becomes a zero potential, output voltage Eo is applied to inductor 13, and inductor current Ix decreases with slope Eo/L. Switch 227 of on-time setting circuit 22B tuns off as a result of drive signal Vg1 falling, switch 235 of off-time setting circuit 23B tuns on as a result of drive signal Vg2 rising, and thus capacitor 27 is charged by the constant current from constant current source 234. Ramp voltage Vr starts to increase after falling below reference voltage Vref, and turn-off signal Vdf falls.

At time t2, when ramp voltage Vr reaches feedback voltage Vfb, the output of comparator 237 rises, and turn-on signal Vdr is output via trigger circuit 238. At the same time, switch 224 turns on as a result of turn-on signal Vdr rising, and ramp voltage Vr becomes reference voltage Vref+Vref1. Since turn-on signal Vdr is a one-shot pulse, switch 224 turns off immediately, capacitor 27 is discharged by current Ia, and ramp voltage Vr starts to fall. When drive signal Vg2 falls by turn-on signal Vdr, low-side switch 12 turns off, then drive signal Vg1 rises and high-side switch 11 turns on, LX terminal voltage Vx changes from the zero potential to input voltage Ei, and the same operations as those subsequent to time t0 are repeated.

Here, time from time t1 to time t2 is off-time Toff of high-side switch 11. The decrease of inductor current Ix during this off-time Toff is expressed as (Expression 25) indicated below.

ΔIx=Eo·Toff/L (Expression 25)

Since this decrease equals to the increase in a steady state, the relationship of (Expression 26) indicated below is obtained.

(Ei−Eo)·Ton=Eo·Toff (Expression 26)

From (Expression 26), Eo=Ei·Ton/(Ton+Toff)=δ·Ei which is the input-output relational expression of buck converter (Expression 1) is obtained. In addition, from (Expression 23) and (Expression 26), the relationship of (Expression 27) indicated below is also obtained.

Eo·Toff=Cr·Vref1·r (Expression 27)

On the other hand, when the current value from constant current source 234 of off-time setting circuit 23B is denoted as Ir, the relationship of (Expression 28) indicated below is obtained.

Vfb−Vref=Ir·Toff/Cr (Expression 28)

When (Expression 27) is substituted into (Expression 28) and Toff is eliminated, the relationship of (Expression 29) indicated below is obtained.

Vfb−Vref=Vref1·r·Ir/Eo (Expression 29)

From Vfb=k·Eo (Expression 2), it can be seen that output voltage Eo, although complex, is expressed by design constants and can be stabilized to an intended value. Here, by setting constant current Ir to Eo/r; that is, by making off-time Toff inversely proportional to output voltage Eo, (Expression 29) is simplified to (Expression 30) indicated below.

Vfb=Vref+Vref1 (Expression 30)

As described above, since the current discharged from capacitor 27 is proportional to the input-output voltage difference (Ei−Eo), time that is until the voltage of high-side switch 11 reaches second voltage (for example, reference voltage Vref) from the first voltage (for example, reference voltage Vref+Vref1), and corresponds to the on-time of high-side switch 11, is inversely proportional to the input-output voltage difference (Ei−Eo). Therefore, as a result of controller 2B including current source circuit 21B and on-time setting circuit 22B, it is possible to make the on-time of high-side switch 11 inversely proportional to the input-output voltage difference (Ei−Eo).

In addition, in consideration of feedback voltage Vfb corresponding to output voltage Eo, time that is until the voltage of capacitor 27 reaches feedback voltage Vfb from the turn-off time point of high-side switch 11, and corresponds to the off-time of high-side switch 11 is set. Therefore, as a result of controller 2B including the feedback circuit (resistors 24 and 25) and off-time setting circuit 23B, it is possible to set the off-time of high-side switch 11 so as to suppress the variation in output voltage Eo, and to stabilize output voltage Eo. Furthermore, since capacitor 27 is shared by on-time setting circuit 22B and off-time setting circuit 23B, it is possible to downsize DC-DC converter 1B.

Also in Embodiment 3, since the on-time is inversely proportional to the input-output voltage difference (Ei−Eo), characteristic that there is substantially no variation in amplitude of the ripple current and the variation in switching frequency is suppressed compared to the case where on-time is fixed is similar to Embodiment 1. What differs from Embodiment 1 is that the configuration of current source circuit 21B is simplified, on-time setting capacitor 220 and off-time setting capacitor 230 are combined into capacitor 27 and the configuration of controller 2B is simplified, and further, generation of the surge current due to short-circuiting the both ends of capacitor 27 is suppressed to reduce noise.

### Other Embodiments

Although the DC-DC converter according to the present disclosure has been described based on Embodiments 1 to 3 thus far, the present disclosure is not limited to these embodiments described above. Other forms in which various modifications apparent to those skilled in the art are applied to the embodiments, or other forms structured by combining some of the structural components of the embodiments are also included within the scope of the present disclosure, unless such changes and modifications depart from the scope of the present disclosure.

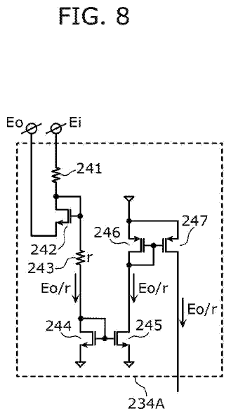

For example, in the above-described Embodiments 1 to 3, the circuit that generates constant current Ir that increases ramp voltage Vr is described as constant current source 234 for simplification, but as described in the description, this current Ir is assumed to be the current proportional to output voltage Eo that is Eo/r, and may be generated using output voltage Eo. FIG. 8 illustrates an example of the circuit that generates constant current Ir (Eo/r) using output voltage Eo.

FIG. 8 is a circuit diagram illustrating a configuration of constant current source 234A according to another embodiment. For example, FIG. 8 is a circuit diagram of constant current source 234A obtained by modifying constant current source 234 of FIG. 6 to flow current Eo/r. In FIG. 8, resistor 241 and NMOS transistor 242 are connected between the node to which input voltage Ei is applied and the node to which output voltage Eo is applied. The Drain and gate of NMOS transistor 242 are connected, and the electric potential thereof becomes Eo+Vgs. The current mirror of NMOS transistors 244 and 245 is connected to the gate of NMOS transistor 242 through resistor 243. Since output voltage Eo is applied to resistor 243, when the resistance value of resistor 243 is set to r, current flowing to the drains of NMOS transistors 244 and 245 becomes Eo/r. By causing the current same as the current flowing from the drain of PMOS transistor 246 to flow from the drain of PMOS transistor 247 by the current mirror of PMOS transistors 246 and 247, constant current source 234A is capable of outputting current Eo/r. In addition, for example, the current generated by constant current source 234 need not necessarily be the current proportional to output voltage Eo, and may be a predetermined constant current.

In addition, in the above-described Embodiments 1 to 3, the ramp voltage to be compared with the feedback voltage has been generated by subtracting the modulation signal corresponding to the ripple current from the reference voltage. However, as described in the explanation of the hysteresis control in the description, a configuration that compares a value obtained by adding the modulation signal to the feedback voltage with the reference voltage may also be employed.

In the above-described Embodiments 1 to 3, the hysteresis control has been used in explaining the control method as placing focus on the advantageous effect of improvement in control stability due to a hysteresis width serving as a control width being constant regardless of input voltage Ei. However, it goes without saying that making the on-time inversely proportional to the input-output voltage difference (Ei−Eo) of the present disclosure can also be applied to control methods other than the hysteresis control. Furthermore, when the variation in amplitude of the ripple current of inductor 13 can be made constant, it means that the maximum condition of an allowable current value is eliminated in selection of inductor 13. In the case of a buck converter, the peak value of an inductor current is obtained by adding a half of the amplitude of the ripple current. When the amplitude of the ripple current is constant, the peak value of the inductor current also becomes constant regardless of input voltage Ei. As can be seen from FIG. 3B, in conventional methods, the amplitude of the ripple current becomes maximum when input voltage Ei is maximum, but the method according to the present disclosure in which the amplitude of the ripple current is constant can substantially reduce the maximum peak value of the inductor current. In other words, it is possible to contribute to the downsizing of inductor 13.

Note that each of the structural components (in particular, the controller) included in the DC-DC converter in the above-described embodiments may be configured in the form of a dedicated hardware product, or may be realized by executing a software program suitable for the structural component. Each of the structural components may be implemented by means of a program executing unit, such as a CPU or a processor, reading and executing the software program recorded on a recording medium such as a hard disk or a semiconductor memory.

Some or all of the functions of the DC-DC converter according to the foregoing embodiments are typically implemented as LSIs which are integrated circuits They may be implemented as a single chip one-by-one, or as a single chip to include some or all thereof. In addition, the integrated circuit is not limited to an LSI, and it may be implemented as a dedicated circuit or a general-purpose processor. A field programmable gate array (FPGA) that is programmable after an LSI is manufactured or a reconfigurable processor that is capable of reconfiguring connection and settings of circuit cells inside an LSI may be employed.

Furthermore, in the future, with advancement in semiconductor technology, a brand-new technology may replace LSI. The structural components included in the DC-DC converter each can be integrated using such a technology.

It should be noted that the present disclosure also includes other forms in which various modifications apparent to those skilled in the art are applied to the embodiments or forms in which structural components and functions in the embodiments are arbitrarily combined within the scope of the present disclosure.

### Others

The descriptions of the embodiments described above disclose the following techniques.

(Technique 1) A DC-DC converter that controls output power of direct current (DC) by controlling on and off of a high-side switch, and the DC-DC converter includes: a controller that adjusts an off-time of the high-side switch for controlling the output power. In the DC-DC converter, the controller makes an on-time of the high-side switch inversely proportional to an input-output voltage difference that is a difference between an input voltage to the DC-DC converter and an output voltage from the DC-DC converter.

According to this, it is possible to achieve both the suppression of the variation in switching frequency and the suppression of the variation in amplitude of the ripple current, by making the on-time of the high-side switch inversely proportional to the input-output voltage difference. More specifically, while suppressing the variation in switching frequency, it is possible to substantially eliminate the variation in amplitude of the ripple current, and achieve stable operations over a wide range of the input voltages.

(Technique 2) The DC-DC converter according to Technique 2, in which the controller includes: a current source circuit that generates a current proportional to the input-output voltage difference; and an on-time setting circuit including an on-time setting capacitor through which the current from the current source circuit flows, and the on-time setting circuit turns off the high-side switch when an amount of change in a voltage of the on-time setting capacitor from a turn-on time point of the high-side switch reaches a predetermined value.

According to this, since the current that is caused to flow through the on-time setting capacitor is proportional to the input-output voltage difference, time that is until the amount of change in voltage of the on-time setting capacitor from the turn-on time point of the high-side switch reaches a predetermined value, and corresponds to the on-time of the high-side switch becomes inversely proportional to the input-output voltage difference. Accordingly, as a result of the controller including the current source circuit and the on-time setting circuit, it is possible to make the on-time of the high-side switch inversely proportional to the input-output voltage difference.

(Technique 3) The DC-DC converter according to Technique 2, in which the controller further includes: a feedback circuit that generates a feedback voltage corresponding to the output voltage; and an off-time setting circuit including an off-time setting capacitor, and the off-time setting circuit: charges a voltage of the off-time setting capacitor up to a predetermined voltage when the high-side switch turns on; discharges the off-time setting capacitor with the current from the current source circuit proportional to the input-output voltage difference, during an on-period of the high-side switch; charges the off-time setting capacitor with a predetermined constant current or a current proportional to the output voltage, during an off-period of the high-side switch; and turns on the high-side switch when the voltage of the off-time setting capacitor reaches the feedback voltage.

According to this, time that is until the voltage of the off-time setting capacitor reaches the feedback voltage from the turn-off time of the high-side switch, and corresponds to the off-time point of the high-side switch is set, by taking into consideration the feedback voltage corresponding to the output voltage. Accordingly, as a result of the controller including the feedback circuit and the off-time setting circuit, it is possible to set the off-time of the high-side switch so as to suppress the variation in output voltage, and thus the output voltage can be stabilized. Furthermore, since the off-time setting capacitor is gradually discharged with current from the current source circuit proportional to the input-output voltage difference during the on-period of the high-side switch, it is possible to suppress the generation of noise compared to the case where the off-time setting capacitor is rapidly discharged.

(Technique 4) The DC-DC converter according to Technique 2, in which the controller further includes: a feedback circuit that generates a feedback voltage corresponding to the output voltage; and an off-time setting circuit including an off-time setting capacitor, and the off-time setting circuit: discharges a voltage of the off-time setting capacitor down to a predetermined voltage during an on-period of the high-side switch; charges the off-time setting capacitor with a predetermined constant current or a current proportional to the output voltage, during an off-period of the high-side switch; and turns on the high-side switch when the voltage of the off-time setting capacitor reaches the feedback voltage.

According to this, time that is until the voltage of the off-time setting capacitor reaches the feedback voltage from the turn-off time point of the high-side switch, and corresponds to the off-time of the high-side switch is set, by taking into consideration the feedback voltage corresponding to the output voltage. Accordingly, as a result of the controller including the feedback circuit and the off-time setting circuit, it is possible to set the off-time of the high-side switch so as to suppress the variation in output voltage, and thus the output voltage can be stabilized.

(Technique 5) The DC-DC converter according to Technique 1, in which the controller includes: a current source circuit that generates a current proportional to the input-output voltage difference; a feedback circuit that generates a feedback voltage corresponding to the output voltage; a capacitor; an on-time setting circuit; and an off-time setting circuit, the on-time setting circuit: charges a voltage of the capacitor up to a first voltage when the high-side switch turns on; discharges the capacitor with the current from the current source circuit proportional to the input-output voltage difference, during an on-period of the high-side switch; and turns off the high-side switch when a voltage of the high-side switch reaches a second voltage lower than the first voltage, and the off-time setting circuit: charges the capacitor with a predetermined constant current or a current proportional to the output voltage, during an off-period of the high-side switch; and turns on the high-side switch when the voltage of the capacitor reaches the feedback voltage.

According to this, since the current discharged from the capacitor is proportional to the input-output voltage difference, time that is until the voltage of the high-side switch reaches the second voltage from the first voltage, and corresponds to the on-time of the high-side switch is inversely proportional to the input-output voltage difference. Accordingly, as a result of the controller including the current source circuit and the on-time setting circuit, it is possible to make the on-time of the high-side switch inversely proportional to the input-output voltage difference. In addition, time that is until the voltage of the capacitor reaches the feedback voltage from the turn-off time point of the high-side switch, and corresponds to the off-time of the high-side switch is set, by taking into consideration the feedback voltage corresponding to the output voltage. Accordingly, as a result of the controller including the feedback circuit and the off-time setting circuit, it is possible to set the off-time of the high-side switch so as to suppress the variation in output voltage, and thus the output voltage can be stabilized. In addition, since the capacitor is shared by the on-time setting circuit and the off-time setting circuit, it is possible to downsize the DC-DC converter.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The DC-DC converter according to the present disclosure can be used as a power supply device that obtains an intended output DC voltage by stepping down from an input DC voltage.

1. A DC-DC converter that controls output power of direct current (DC) by controlling on and off of a high-side switch, the DC-DC converter comprising:
a controller that adjusts an off-time of the high-side switch for controlling the output power, wherein
the controller makes an on-time of the high-side switch inversely proportional to an input-output voltage difference that is a difference between an input voltage to the DC-DC converter and an output voltage from the DC-DC converter.

2. The DC-DC converter according to claim 1, wherein
the controller includes:
a current source circuit that generates a current proportional to the input-output voltage difference; and
an on-time setting circuit including an on-time setting capacitor through which the current from the current source circuit flows, and
the on-time setting circuit turns off the high-side switch when an amount of change in a voltage of the on-time setting capacitor from a turn-on time point of the high-side switch reaches a predetermined value.

3. The DC-DC converter according to claim 2, wherein
the controller further includes:
a feedback circuit that generates a feedback voltage corresponding to the output voltage; and
an off-time setting circuit including an off-time setting capacitor, and
the off-time setting circuit:
charges a voltage of the off-time setting capacitor up to a predetermined voltage when the high-side switch turns on;
discharges the off-time setting capacitor with the current from the current source circuit proportional to the input-output voltage difference, during an on-period of the high-side switch;
charges the off-time setting capacitor with a predetermined constant current or a current proportional to the output voltage, during an off-period of the high-side switch; and
turns on the high-side switch when the voltage of the off-time setting capacitor reaches the feedback voltage.

4. The DC-DC converter according to claim 2, wherein the controller further includes:
a feedback circuit that generates a feedback voltage corresponding to the output voltage; and
an off-time setting circuit including an off-time setting capacitor, and
the off-time setting circuit:
discharges a voltage of the off-time setting capacitor down to a predetermined voltage during an on-period of the high-side switch;
charges the off-time setting capacitor with a predetermined constant current or a current proportional to the output voltage, during an off-period of the high-side switch; and
turns on the high-side switch when the voltage of the off-time setting capacitor reaches the feedback voltage.

5. The DC-DC converter according to claim 1, wherein
the controller includes:
a current source circuit that generates a current proportional to the input-output voltage difference;
a feedback circuit that generates a feedback voltage corresponding to the output voltage;
a capacitor;
an on-time setting circuit; and
an off-time setting circuit,
the on-time setting circuit:
charges a voltage of the capacitor up to a first voltage when the high-side switch turns on;
discharges the capacitor with the current from the current source circuit proportional to the input-output voltage difference, during an on-period of the high-side switch; and
turns off the high-side switch when a voltage of the high-side switch reaches a second voltage lower than the first voltage, and
the off-time setting circuit:
charges the capacitor with a predetermined constant current or a current proportional to the output voltage, during an off-period of the high-side switch; and
turns on the high-side switch when the voltage of the capacitor reaches the feedback voltage.
